(19) United States
(12) Patent Application Publication
(10) Pub. No.: US 2013/0332336 A1
(43) Pub. Date: Dec. 12, 2013

(54) MORTGAGE RELATIONSHIP PRICING

(71) Applicants: Ashley C. Hardy, Charlotte, NC (US); Charlotte F. Baker, Lexington, SC (US); Carol H. Doyle, Lynn, MA (US); Joseph A. Ferro, III, Charlotte, NC (US); William R. Wick, Charlotte, NC (US)

(72) Inventors: Ashley C. Hardy, Charlotte, NC (US); Charlotte F. Baker, Lexington, SC (US); Carol H. Doyle, Lynn, MA (US); Joseph A. Ferro, III, Charlotte, NC (US); William R. Wick, Charlotte, NC (US)

(73) Assignee: Bank of America, Charlotte, NC (US)

(21) Appl. No.: 13/494,172

(22) Filed: Jun. 12, 2012

(51) Int. Cl. G06Q 40/02

(52) U.S. Cl. 705/38

(57) ABSTRACT

Methods and apparatus according to the invention are directed towards providing an offer of discounted pricing of a mortgage product to a customer of a financial institution. Depth of discounting may be related to an extent of the customer's financial relationship with the institution. Assessing the extent may include evaluation of the customer's institutional financial holdings. The methods and apparatus support offering a depth of discounting related to a future extent of the customer's institutional relationship.

### FIELD OF TECHNOLOGY

This disclosure relates to systems and methods for offering relationship-based pricing on loan products. More specifically, the disclosure relates to offering to a customer of a financial institution entity a discount on pricing of a mortgage. The discount may be programmatically based upon a relationship of the customer with the entity. The relationship may include the customer being an accountholder of one or more entity financial instruments.

### BACKGROUND OF THE INVENTION

A financial institution entity (hereinafter, in the alternative, “entity”), such as a bank, at which a customer holds a financial account may typically have access to information regarding the account's current status and past history. Information regarding account status and history that may be accessible to the entity may include: current balance; past balances; patterns of the customer's account use; notations as to circumstances of account overdrafts and/or delinquencies; and other data pertaining to maintenance and performance of the account. Such entity-internal information may contribute to entity-knowledge of the customer's financial standing and financial track-record.

Entity-knowledge of the customer's financial standing and financial track-record may begin to accumulate upon opening of the entity account. Opening the account may require the customer to present information to the entity regarding aspects of the customer's financial standing. The longer the customer may hold the account at the entity subsequent to opening it, the more extensive may be entity-knowledge of the customer's financial standing. The longer the customer may hold the account at the entity subsequent to opening it, the more extensive may be, also, entity-knowledge of the customer's financial track-record.

Should the customer hold multiple accounts at the entity, entity-knowledge of the customer's financial standing and financial track-record may be wider and more reliable than such knowledge that may be available to the entity through the customer holding a single entity account.

Should one or more customer-held entity accounts be an investment account managed by and/or through the entity, entity-assessment of the customer's financial standing may include measures of future evaluations of the investment account and of the customer's investment track-record, risk-tolerance and risk-handling.

Customer-held entity loan products may be a source of entity-internal information that may contribute to entity-knowledge of the customer's financial status. Entity records of the customer's history of handling entity loan products may provide track-record information. Entity loan products may include first mortgages, second mortgages, home equity lines of credit and home equity loans.

The entity may be a multi-service financial institution entity that may be a mortgagee to which a customer may be obligated under one or more mortgages; i.e., the customer may be a mortgagor of property or properties of which the entity may be the mortgagee. Entity-knowledge of the customer's financial standing and financial track-record may include data pertaining to the one or more mortgages. Should the customer also hold other financial instruments with the entity, such as accounts and/or investments, as above, entity-knowledge of the customer's financial standing and financial track-record may be substantial.

Generally, the broader (e.g., in number of different accounts) and deeper (e.g., in account longevity and/or account valuation) the customer's relationship may be with the entity, the more extensive and reliable may be entity-knowledge of the customer's financial standing and financial track-record.

The customer may benefit from the extent and reliability of entity-knowledge of the customer's financial standing and financial track-record. A circumstance in which the customer may benefit from the extent and reliability of such entity-knowledge may be the circumstance in which the customer may be seeking a mortgage. The customer may be an applicant applying to the entity for the mortgage. The entity may offer the customer that is a mortgage applicant (hereinafter, in the alternative, “applicant/customer”) mortgage pricing favorable to the applicant/customer. Such favorable pricing may be based upon the extent and reliability of entity-knowledge of the applicant/customer's financial standing and financial track-record. Such applicant/customer-favorable relationship-based mortgage pricing may reflect a degree of entity risk-reduction.

A mortgage may represent a risk to a mortgagee. A factor in assessing that risk may be mortgagee-assessment of a potential mortgagor's financial standing and financial track-record. A mortgagor's ability to reliably fulfill contractual obligations of a mortgage may directly correlate with the mortgagor's financial standing and financial track-record. The greater the uncertainty surrounding a potential mortgagor's financial standing and financial track-record, the higher may be the risk to be assumed by the mortgagee. A mortgagee lacking extensive, reliable knowledge of an applicant's financial standing and financial track-record may necessarily expend fiduciarily mandated resources of time, effort and money to obtain enough such knowledge to lower that risk to an acceptable level.

A mortgagee that, already at the time of an applicant applying for a mortgage, may possess knowledge of the applicant's financial standing and financial track-record, may save on risk-lowering expenditures associated with obtaining such knowledge. The more extensive and reliable a mortgagee's knowledge may be at the time of an applicant applying for a mortgage of the applicant's financial standing and financial track-record, the lower may be mortgagee-expenditures associated with obtaining risk-lowering knowledge of the applicant's financial standing and financial track-record.

Thus, the multi-service financial institution entity's entity-knowledge, already at the time of the applicant/customer applying for the mortgage, of the applicant/customer's financial standing and financial track-record, may facilitate risk-assessment and may represent entity-savings in risk-assessment expenditures. In addition, the customer entity relationship that may engender that entity-knowledge may serve to reduce entity risk-management expenditures. Such reduction of entity risk-management expenditures may be multi-fold. The customer being an entity accountholder and/or financial instrument-holder, may make more likely ongoing communication between the mortgagor (the account/instrument-holding customer) and the mortgagee (the account/instrument-maintaining entity). Such ongoing communication may mitigate likelihood of mortgage default. In addition, standard entity-monitoring of maintenance and/or performance parameters of the customer's entity accounts and/or financial instruments may provide, over the lifetime of the mortgage, “early-warning” signaling of potentially mortgage-impacting financial issues affecting the mortgagee.

The entity may utilize expenditure-savings in risk-assessment and risk-management that may accrue to the entity from entity-knowledge of the applicant/customer's financial standing and financial track-record, to offer the applicant/customer mortgage pricing favorable to the applicant/customer. Alternatively and/or additionally, applicant/customer-favorable relationship-based mortgage pricing may be offered to the applicant/customer on the basis of value that the entity assesses in, and/or attributes to, the breadth and depth of the customer entity relationship, such value independent of expenditure-savings in risk-assessment and risk-management.

The applicant/customer-favorable relationship-based mortgage pricing may include a discounting of one or more mortgagor-costs associated with the mortgage. Such applicant/customer-favorable relationship-based mortgage pricing may include a mortgage pricing saving in the form of lower origination fees and/or closing costs. Such applicant/customer-favorable relationship-based mortgage pricing may include one or more adjustments of terms of a variable mortgage to better match projected timelines of the applicant/customer's expected future income-streams and expected future expenses. Such applicant/customer-favorable relationship-based mortgage pricing may include any suitable set of monetary conditions that may be favorable to the applicant/customer.

An entity-offer of applicant/customer-favorable relationship-based mortgage pricing may encourage the applicant/customer to further pursue obtaining the mortgage through the entity and may, then, lead to a successful transacting of the mortgage between the entity as mortgagor and the applicant/customer as mortgagee. Such applicant/customer-encouragement and consequent successful transacting of the mortgage may be dependent upon optimizing the terms of the entity's applicant/customer-favorable relationship-based mortgage pricing offer. Optimization of the terms of the relationship-based mortgage pricing offer may be dependent upon assessment of the depth and the breadth of the customer's entity relationship. Assessment of the depth and the breadth of the applicant/customer's entity relationship may require aggregating and processing relevant customer account data and/or financial-instrument data.

Applicant/customer-encouragement and consequent successful transacting of the mortgage may be dependent also upon the timeliness of the entity's relationship-based mortgage pricing offer. The timeliness of the offer may peak close after the applicant/customer's applying for the mortgage. The less time that may elapse between the applicant/customer's applying for the mortgage and the entity optimizing and proffering the relationship-based mortgage pricing offer, the more likely may be the entity's successful transacting of the mortgage with the applicant/customer.

Thus, the entity's successful transacting of the mortgage with the applicant/customer may be dependent upon the terms and timeliness of the entity's relationship-based mortgage pricing offer, which may be dependent upon rapidly and efficiently aggregating and processing applicant/customer entity relationship data. However, such aggregation and processing may be stymied by distribution of the requisite data among diverse divisions of the multi-service entity, where the data may, additionally, be in diverse and/or incompatible formats. Further, processing aggregated data into assessments of applicant/customer entity relationship may be an insufficient, though necessary, step toward timely proffering of an optimized offer of applicant/customer-favorable relationship-based mortgage pricing.

Thus, there may exist a need for apparatus and methods for rapid, efficient aggregation of applicant/customer entity relationship data. Further, there may exist a need for apparatus and methods for rapid, efficient and consistent processing of aggregated applicant/customer entity relationship data into assessments of the applicant/customer's entity relationship and for conversion of such assessments into optimized applicant/customer-favorable relationship-based mortgage pricing offers.

It would be desirable, therefore, to provide apparatus and methods for efficiently aggregating an applicant/customer's entity relationship data; for rapidly processing such data into assessments of the applicant/customer's entity relationship; and for timely, consistent and effective conversion of such assessments into optimized applicant/customer-favorable relationship-based mortgage pricing offers.

### SUMMARY OF THE DISCLOSURE

It is an object of this invention to provide apparatus and methods for timely, consistent and effective conversion of assessments of an applicant/customer's entity relationship into optimized applicant/customer-favorable relationship-based mortgage pricing offers. It is also an object of this invention to provide apparatus and methods for rapidly processing the applicant/customer's entity relationship data into assessments of the applicant/customer's entity relationship. It is also an object of this invention to provide apparatus and methods for efficiently aggregating the applicant/customer's entity relationship data.

The need for apparatus and methods to effect timely optimization and proffering of applicant/customer-favorable relationship-based mortgage pricing offers may be acute for an entity capable of offering highly favorable relationship-based mortgage pricing. Such capability may directly correlate with an entity's breadth of service-offerings and depth of resources. An entity with significant breadth of service-offerings and depth of resources may, potentially, be able to offer highly favorable relationship-based mortgage pricing. However, practically, such an entity's significant breadth of service-offerings and depth of resources may interfere with achieving such an offer in an optimized, timely fashion.

The broader an entity's service-offerings may be—including types of accounts, financial instruments, investments loan products and other entity products available through diverse divisions of the entity—the broader and deeper may be an applicant/customer's entity relationship and, correspondingly, the broader and deeper may be entity-knowledge of the applicant/customer's financial standing and financial track record. Correspondingly, also, entity-expenditures relating to risk-assessment and risk-management may be low, potentially facilitating highly favorable relationship-based mortgage pricing.

An entity's breadth of service-offerings and depth of resources may also be reflected in the range and variety of mortgages available through the entity's mortgage-issuing division(s). A broad range of diverse mortgage-products may present a high likelihood of fitting an available mortgage to the financial circumstances of a given applicant, with such mortgage potentially to be made more appealing to the applicant by applicant/customer-favorable relationship-based pricing.

In addition, a mortgage-issuing multi-service entity may be involved through its own divisions and/or in-house staff in multiple aspects of mortgage-issuance. Such aspects may include: evaluation of property (e.g., appraisal, title search); evaluation of an applicant's credit-worthiness; loan processing (e.g., deed-recording); mortgage approval; and loan servicing. Generally, the more an entity may make use of entity-services (e.g., in-house legal counsel) in execution of diverse aspects of mortgage-issuance, the lower may be entity-expenditures relative to those of mortgage-issuers making use of outside services in the execution of those aspects of mortgage-issuance. Such expenditure-savings may potentially contribute to applicant/customer-favorable relationship-based pricing.

The deeper an entity's resources, the better may be the entity's fiscal stance allowing for discounting of mortgage pricing. A well-established entity with significant breadth of service-offerings and depth of resources may be well positioned to offer, for example, to assume or waive some portion of the mortgage principal loan amount. Such an entity may have the means to readily offer, for example, to grant a bridge-loan allowing an applicant to take advantage of favorable mortgage terms available during a restricted timeframe. Such an entity may routinely offer, for example, to cover a cost of some portion of one or more points on a mortgage. Such offers of setting applicant/customer-favorable monetary conditions may be within the standard capabilities of a well-established entity with significant breadth of service-offerings and depth of resources, but not within the purview of a smaller financial institution with more modest breadth of service-offerings and/or with more limited depth of resources.

However, a well-established entity with significant breadth of service-offerings and depth of resources, may not be sufficiently nimble to aggregate and process applicant/customer-entity data in an efficient enough manner to proffer a timely optimized applicant/customer-favorable relationship-based mortgage pricing offer. The older and better established a financial services entity may be, the more likely its various branches and divisions may be to harbor records in mutually incompatible data formats of sundry provenance. Such branches and divisions may be likely to be widely distributed as to geography and age, such distributions likely to render communications less facile. The broader an entity's service-offerings and the more widely the service-offerings may be distributed across an entity's divisions, the lower may be the likelihood of achieving rapid, efficient inter-service and/or inter-divisional data exchange. In addition, to the extent that acquisitions of, and/or mergers with, other financial institutions may contribute to an entity's breadth of services and depth of resources, the greater may be obstacles to intra-entity communications.

The apparatus and methods of this invention may provide for exchange and aggregation of data through communication of data-requests to, and communication of requested data from, all relevant elements of the entity. The timing, form, content, processing and/or coordination of such data-requests and requested data may be determined by apparatus and methods of the invention. The elements of the entity may include divisions, departments, branches, affiliates, offices, in-house data-storage facilities, remote electronic sites and any other suitable host(s) of data and/or of data-processing relevant to customer entity relationships. The provision of such format-transparent communication may take the form of standardization of data-formats across the entity; may take the form of format-translation/compatibility modules and/or means compensating for data-format differences; may take the form of limited communication of invention-specific data-transfers in a selected range of formats; and/or may take any other suitable form of apparatus and/or methods that may expedite aggregation of entity relationship data. Such other suitable form of apparatus and/or methods that may expedite aggregation of entity relationship data may include wireless human-to-human communication complementing, supplementing and/or bypassing digital electronic data-transfer.

The apparatus and methods of this invention may provide for processing of data relevant to an applicant/customer into assessments of the applicant/customer entity relationship. Such assessments may characterize the breadth and depth of the applicant/customer's holdings at, and history with, the entity. The provision of such data-processing may take the form of modules and/or means for processing relevant applicant/customer data to arrive at relationship characterizations. Such relationship characterizations may be categorizations of the applicant/customer entity relationship. Such categorizations may each span a range of customer entity relationships of particular breadth and depth.

The apparatus and methods of this invention may provide for conversion of assessments of an applicant/customer entity relationship into optimized applicant/customer-favorable relationship-based mortgage pricing offers. The provision of such conversions may take the form of modules and/or means for comparison of assessments of the applicant/customer entity relationship against reference relationships. Reference relationships may be based upon entity experience with accountholders and/or with financial instrument-holders. Reference relationships may represent a range of entity customer relationships of various breadths and depths. Reference relationships may be characterizations of entity relationships of various breadths and depths. Reference relationships may be categorizations of entity customer relationships of various breadths and depths.

Reference relationships may be stored. The storage of reference relationships may be dynamic. The number and/or variety of stored reference relationships may be non-static.

Reference relationships may be scored. The scoring of reference relationships may include linkage of a set of reference relationships to a set of mortgage pricing modes. The linkage may be dynamic; the mortgage pricing modes may be dynamic. Such linkages and such pricing modes may be determined and/or modified by the entity in keeping with entity-selected considerations.

Such storage, scoring, linking, determining and modifying may be carried out prior to and independent of assessment of the applicant/customer's entity relationship. Comparison of assessments of the applicant/customer entity relationship against stored, scored reference relationships may be directed to determination of one or more close matches among the reference relationships to the applicant/customer entity relationship. Determination of such close matches may associate the applicant/customer entity relationship with the mortgage pricing modes linked to the reference relationship(s) matching the applicant/customer entity relationship. Application of the associated mortgage pricing modes to the applicant/customer's entity relationship may yield an optimized applicant/customer-favorable relationship-based mortgage pricing, which may then be proffered as an offer.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 is a block diagram of hardware apparatus that may be used in accordance with principles of the invention; and

FIG. 2 is an illustrative flow diagram of a process in accordance with principles of the invention.

### DETAILED DESCRIPTION OF THE DISCLOSURE

Apparatus, methods and media for providing relationship-based loan product pricing to a customer of a financial services entity are provided. The apparatus may include, and the methods and media may involve, components and functions that provide relationship-based loan product pricing valuations to an entity-customer that is an applicant applying for an entity loan product. The loan product may be a mortgage product offered by the entity. The entity mortgage product may be a first mortgage, a second mortgage, a home equity line of credit or a home equity loan.

Offering mortgages may be a subset of mortgage-issuance activities of the entity. Such mortgage-issuance activities may include property-appraisals, title searches, credit checks, deed-recording, mortgage approval, mortgage servicing, and other suitable mortgage-related activities. Such mortgage-issuance activities may be carried out by a mortgage-issuing division(s) of the entity.

Mortgage-issuance activities may be a subset of financial activities of the entity. For a multi-service entity, such financial activities may include maintaining customer savings and/or checking accounts; servicing customer credit and/or debit card accounts; managing customer investment accounts; offering and/or issuing a variety of financial instruments, such as loan products that may include mortgages; and other suitable financial services activities. Non-mortgage-issuance financial activities may be carried out by divisions of the entity other than the mortgage-issuing division(s) of the entity.

A set of loan product pricing modes may be invoked for the applicant. The set of loan product pricing modes may be a subset of a pricing modes rubric governing loan product pricing. The pricing modes rubric may be based upon entity loan product experience. The pricing modes rubric may be a subset of a collection of experience-based, adjustable, entity-set rubric and rules that may govern select apparatus, processes, methods and means according to this invention. The collection of entity-set governing rubrics and rules may include subsets of rubrics and rules that are entity-defined and/or entity-limited in scope and/or applicability by geographic area, calendar date, duration and/or other parameters. Such other parameters may include relevant measures of real estate market robustness.

Subsets of the set of loan product pricing modes may include one or more loan product pricing modes. Subsets of loan product pricing modes may be selected to calculate loan product pricing. Selection of one or more subsets of loan product pricing modes may result in the applicant being offered the loan product with loan product pricing calculated according to the loan product pricing mode(s) comprising the selection.

Selection of one or more subsets of loan product pricing modes may result in the applicant being offered conventional pricing on the loan product, with no special pricing considerations favoring the applicant. Selection of one or more subsets of loan product pricing modes may result in the applicant being offered loan product pricing that may be unfavorable to the applicant. Selection of one or more subsets of loan product pricing modes may result in the applicant being offered special loan product pricing. The special pricing may include loan-related monetary conditions that may be favorable to the applicant.

Loan-related monetary conditions that may be favorable to the applicant may include reduction of one or more interest rates of a loan product. Applicant-favorable loan-related monetary conditions may include reduction of one or more origination fees and/or closing costs. Applicant-favorable loan-related monetary conditions may include a monetary consideration to be awarded to the applicant before, during and/or after mortgage closing. Such consideration may include funds-transfer to, and/or applicant-favorable effects on, existing and/or future applicant-held entity accounts, instruments and/or other products. Such consideration may include applicant-favorable effects on entity programs in which the applicant may participate. Such consideration may include funds-transfer to a charitable cause of the applicant's choice. Such consideration may include funds-transfer directly to the applicant.

Applicant-favorable loan-related monetary conditions may include one or more adjustments of terms of a variable mortgage to better match a projected timeline of the applicant's expected future income-streams and expected future expenses. Applicant-favorable loan-related monetary conditions may include parameters of a bridge loan to accommodate the applicant's circumstances. Applicant-favorable loan-related monetary conditions may include waiving and/or assuming a portion of a mortgage principal loan amount. Applicant-favorable loan-related monetary conditions may include any suitable change of parameters of loan-product-issuance that favors the applicant. Such suitable changes of parameters of loan-product-issuance may include the entity paying for some portion of one or more points on a mortgage.

One or more subsets of loan product pricing modes may specify which loan-related monetary condition(s) may be subject to change. One or more subsets of loan product pricing modes may specify the degree of change to which a loan-related monetary condition may be subject.

The selection of one or more subsets of loan product pricing modes may be based upon a value associated with, and/or a categorization of, a relationship of the applicant with the entity. The relationship of the applicant with the entity (hereinafter, “applicant entity relationship profile” or “applicant profile”) may be associated with the value and/or categorized as the categorization (hereinafter, “category-value”). Association of a category-value with an applicant profile, as well as with a selected subset of loan product pricing modes, may be based upon one or more subsets of the collection of entity-set governing rubrics and rules.

The applicant profile category-value may serve as a basis for selecting one or more subsets of loan product pricing modes for calculating loan product pricing that may be offered to the applicant. For example, an amount of savings offered the applicant in mortgage origination fees and/or closing costs may depend upon the applicant profile category-value. A more favorable category-value may confer on the applicant an offering of more savings than would a less favorable category-value.

A category-value may reflect a degree of a time-currency (i.e., of a state of being current in time) of the applicant entity relationship profile. An applicant may be an entity-customer with a pre-existing relationship with the entity. That relationship may be current at the time of the applicant applying for the entity loan product. An applicant may not have a current relationship with the entity at the time of applying for the entity loan product, but may have had a relationship with the entity for some time-period prior to applying for the loan product. An applicant may not have had a relationship with the entity prior to applying for the entity loan product, and the customer's current applying for the loan-product may be the full extent of the applicant's current relationship with the entity. An applicant may, at a projected time of granting of the loan product (e.g., in the case of the loan product being a mortgage, at the time of mortgage approval or at the time of mortgage closing) or at some other future time, have a projected relationship with the entity that may be different from the current relationship the applicant has with the entity.

A category-value may reflect a characterization of a breadth and/or a depth of the applicant entity relationship profile. A characterization by breadth of the applicant entity relationship profile may include a number-count of applicant-held entity accounts and/or entity financial instruments. Entity accounts and/or entity financial instruments may include investments managed by the entity and/or mortgages offered by the entity. A characterization by breadth of the applicant entity relationship profile may include a number-count of other entity financial products held by the applicant and/or maintained by the entity on behalf of the applicant, and/or of entity financial programs in which the applicant may participate.

A characterization by depth of the applicant entity relationship profile may include monetary evaluations of all, each or any of the entity accounts, entity financial instruments and/or other entity financial products held by the applicant. A characterization by depth of the applicant entity relationship profile may include factors relating to interest rates and/or maturation dates attached to applicant-held entity accounts, entity financial instruments and/or other entity financial products. A characterization by depth of the applicant entity relationship profile may include measures of the projected future value of, and/or of risk associated with, applicant-held entity accounts, entity financial instruments and/or other entity financial products. A characterization by depth of the applicant entity relationship profile may include any other suitable measure.

A category-value may reflect other factors that may be used separately from, or in conjunction with, the aforementioned time-currency and relationship account characterizations. Such other factors may include an applicant's track-record with respect to applicant-held entity accounts, entity financial instruments and/or other entity financial products, including other mortgages. An applicant track-record may consider a time-duration of an applicant being an entity accountholder, instrument-holder and/or product-holder for each applicant-held entity account, entity financial instrument and/or other entity financial product. An applicant track-record may consider an applicant's reliability and timeliness in fulfilling contracted obligations associated with applicant-held entity accounts, entity financial instruments and/or other entity financial products. An applicant track-record may consider an applicant's communications with the entity regarding applicant-held entity accounts, entity financial instruments and/or other entity financial products. An applicant track-record may consider other suitable indicators and/or records of applicant trustworthiness over time. Such other factors that may be reflected in a category-value may include measures of an applicant's risk-appetite and risk-tolerance.

A category-value may be arrived at by combining the aforementioned factors—account time-currency, relationship account characterizations, track-record factors of trustworthiness and risk—and any other suitable measures, according to entity-determined combination rules that may be subsets of the collection of entity-set governing rubrics and rules. Data contributing to and/or comprising the time-currency, characterizations, track-record factors and/or other suitable measures may be resident in the mortgage-issuing division(s) of the entity. All or some of the data may be resident in other entity divisions. All or some of the data may be resident in, and/or distributed over, remote sites. The mortgage-issuing division(s) may have access to data that may be resident in other entity divisions and/or in remote sites and/or distributed over remote sites. Likewise, processing of data contributing to and/or comprising the time-currency, characterizations, track-record factors and/or other suitable measures may be carried out at sites local to and/or remote from entity divisions.

Given the data comprising the aforementioned time-currency, characterizations, track-record factors and/or other suitable measures, the combination rules may consider all, each, any or none of the time-currency, characterizations, track-record factors and/or other suitable measures, weighing and combining them as determined by the entity to arrive at a category-value. The category-value may be scaled by number, by letter, by color and/or in any other suitable fashion. Such other suitable fashion may include scaling by name designation.

For example, the entity may employ a system by which category-value may be scaled by number. Such a system may assign a scaled number valuation and/or a scaled number weight to each of the time-currency, characterizations, track-record factors and/or other suitable measures; this system may combine such weighted valuations to arrive at a category-value for a given applicant. Such a category-value number system may, for example, be scaled from a least favorable “0” to a most favorable “10.”

Category-values may be arrived at independent of actual applicants. Category-values may be arrived at in anticipation of prospective applicants. Such category-values may reflect possible scenarios of account time-currency, relationship account characterizations, track-record factors of trustworthiness and risk, along with other suitable measures. Such scenarios characterizing anticipated/prospective applicants may be built from the entity's experience with actual entity applicants and entity accountholders. Such scenarios characterizing anticipated/prospective applicants may be stored as reference entity relationship profiles (hereinafter, in the singular, “reference profile”), each assigned a category-value.

For example, a reference profile may represent an anticipated/prospective applicant currently (i.e., at the time of applying) holding no entity accounts and no entity financial instruments, and with no history of ever having held any entity accounts or entity financial instruments. Such an exemplary reference profile may have an assigned category-value of 1. Other scenarios, which may represent an anticipated/prospective applicant that is currently an entity accountholder, but with total holdings across all accounts being below an entity-set threshold or with account-holdings in one or more of several accounts being below account-specific thresholds, may also have an assigned category-value of 1.

Another exemplary reference profile may represent an anticipated/prospective applicant with a current entity account and/or a current entity mortgage, but with a history of serious delinquencies in fulfilling obligations associated with entity accounts or entity mortgages. Such a reference profile may have an assigned category-value of 0.

Yet another exemplary reference profile may represent an anticipated/prospective applicant with two entity accounts, with one of the accounts being a generally growing savings account established at least three years before (i.e., before the time of applying) and with current holdings of between $4,000 and $8,000. The other account may be either a business checking account transacting $25,000 to $50,000 of business a month, or a moderate-risk investment account with a present value of $10,000 to $20,000. Such a reference profile may have an assigned category-value of 4.

In a similar scenario, an anticipated/prospective applicant may hold only the above-specified savings account or only one of the two above-specified other accounts. Such a scenario may be represented by an exemplary reference profile to which may be assigned a category-value of 3.

In yet another similar scenario, an anticipated/prospective applicant may hold the above-specified entity savings account in addition to both the above-specified entity business checking account and the above-specified entity investment account. Such a scenario may be represented by an exemplary reference profile to which may be assigned a category-value of 5.

A particular subset of loan product pricing modes may be linked to each category-value. Alternatively and/or additionally, a particular subset of loan product pricing modes may be linked to each reference profile. Alternatively and/or additionally, a particular subset of loan product pricing modes may be linked to an assessment of an applicant profile of a mortgage applicant, the assessment being current with, and/or proximal to, the applicant's applying for the mortgage. Alternatively and/or additionally, a particular subset of loan product pricing modes may be linked to an assessment of an applicant profile of a mortgage applicant, the assessment being a projected assessment for some future time after the applicant's applying for the mortgage. Alternatively and/or additionally, a particular subset of loan product pricing modes may be linked to an applicant profile of a mortgage applicant.

Details of scenarios anticipated and stored, including a total number of scenarios, may be adjusted in a fashion determined by the entity. Assignment of category-values to reference profiles and/or to applicant profiles and/or to scenarios, may be adjusted in a fashion determined by the entity. The set of loan product pricing modes and/or the linkages of subsets of loan product pricing modes to reference profiles and/or to applicant profiles and/or to scenarios, may be adjusted in a fashion determined by the entity. These and other adjustments may be made by adjusting subsets of the collection of entity-set governing rubrics and rules. Such collection may archive earlier, pre-adjustment sets of rubrics and rules.

The apparatus may include, and the methods and media may involve, components and functions that process entity relationship profiles. Such components and functions may include entity inter-divisional communication components and functions, as well as components and functions for receiving/retrieving, logically processing and/or storing data. The data may be received from an actual applicant. The data may be received and/or retrieved from entity data-storage facilities and/or entity data-processing facilities.

Entity relationship profiles that may be received, processed and/or stored by the components and functions of the invention may include applicant profiles of actual applicants and/or reference profiles of anticipated/prospective applicants.

The processing may include characterizing the profiles. The characterization of the profiles may include each profile being assigned a category-value. The category-value may reflect aspects of a relationship of an applicant, actual or anticipated/prospective, with the entity. Diverse profiles may be assigned different category-values. Diverse profiles may each be assigned a single category-value. A category-value and/or a profile may serve as a selection criterion for selecting a subset of loan product pricing modes that may be used to calculate relationship-based loan product pricing that may be offered an applicant applying for an entity loan product.

For example, an applicant applying for an entity mortgage product may typically be prescreened on the basis of data pertaining to applicant finances and pertaining to the property to be mortgaged. Such data may be received from the applicant. Such data may be retrieved from data-storage. The prescreening may assess the applicant as to an entity loan-qualification score. The entity loan-qualification score may tentatively set—pending verification of applicant financial data and pending the results of pre-approval mortgage-related investigations—several parameters of the mortgage according to a subset of the collection of entity-set governing rubrics and rules. Such parameters may include mortgage type, mortgage term, interest rate(s), minimum down-payment amount, points at closing, and/or other suitable parameters. Such other suitable parameters may include origination fees and/or closing costs.

According to methods and processes carried out by the components and functions of the present invention, an applicant may be identified through received data and/or retrieved data as being a current entity accountholder, an applicant/customer. In an illustrative exemplary case of such an applicant/customer, the applicant/customer may be applying (and/or may be prescreened) for a fixed-rate mortgage. The applicant/customer may be identified as holding two entity accounts, one being a savings account opened ten years before the applying and the other being an investment account started one year before the applying. The savings account may currently hold a balance of $5,000, with an average holding of $4,000 over the last year, of $2,500 over the most recent five years and of $1,000 over all ten years. The investment account may be a moderate-risk account that the accountholder started with $10,000; despite downward market fluctuations, the accountholder may have continued to contribute to the investment account in small increments over the year, such that the account may currently be valued at $10,500; the investment account may have a projected future growth rate over the next year, independent of future accountholder contributions, of 10%.

In this example, the applicant's applicant profile may be determined to most closely match the exemplary reference profile, above, assigned a category-value of 4. Category-value may, for example, be linked to a subset of loan product pricing modes that confer a 50% reduction in mortgage origination fees and closing costs. Thus, an entity loan officer handling the application of the applicant/customer may inform the applicant that the applicant's applicant profile may qualify the applicant to be offered a special mortgage pricing of 50% reduction in origination fees and closing costs. Expeditious processing of data received from the applicant, of applicant-pertinent data received from entity non-mortgage-issuing divisions, and of stored reference profile data according to the present invention may enable the loan officer to inform the applicant of the special pricing offer in a timely fashion proximal to the applicant applying for the mortgage. Such a timely offer of special pricing may encourage the applicant to follow through with the entity application process and may subsequently lead to the applicant securing the mortgage with the entity as mortgagee of the property.

Further pursuing the same example, the loan officer may note, from application data of the applicant and/or from other data pertinent to applicant finances, that the applicant may be an owner of a small business transacting an average of $60,000 of business a month, but not, as evident from the applicant's applicant profile, through any division of the entity. In exploring possible upgrading of the applicant's applicant profile to match a reference profile assigned a higher category-value, the loan officer may process several reference profiles as projected applicant profiles. The reference profiles processed as projected applicant profiles may be similar to the applicant's actual current applicant profile but may contain the added feature of an entity business checking account transacting various ranges of monthly business volume.

The loan officer may contact the applicant, explaining that an applicant profile associated with more favorable special pricing may be available to the applicant. The loan officer may further explain that such more favorable applicant profile may be attained through the applicant transferring the applicant's business checking to the entity and through the applicant's average volume of monthly business checking meeting specified requirements. Further description of conditions to be met to attain the upgrade may include a timeframe in which adjusting the applicant's applicant profile to match the projected applicant profile may impact mortgage pricing. Such timeframe may extend to the date of mortgage approval. Such timeframe may extend to the date of mortgage closing. Such timeframe may accommodate a “residency requirement” for a new entity account to establish an account history. Such residency requirement may be a month.

Returning to the extended example, the applicant may express interest in investigating a more favorable special pricing. The applicant may inform the loan officer that, of the applicant's average total monthly business transactions of $60,000, monthly business checking volume averages $35,000. The loan officer, having processed the projected applicant profiles, may respond to the applicant's information with specifics of mortgage pricing advantages that may accrue to the applicant from transacting $35,000 of monthly business checking through an entity business checking account.

By addition of a $35,000/month business checking account to the applicant's current entity holdings, the applicant's projected applicant profile may most closely match the exemplary reference profile, above, assigned a category-value of 5. Category-value 5 may, for example, be linked to a subset of loan product pricing modes that may present a choice of two options of applicant/customer-favorable mortgage pricing. The options may be a 90% reduction in mortgage origination fees and closing costs, or a reduction of 5 basis points in mortgage fixed-interest rate.

Concluding the illustrative example, the loan officer's reaching out to the applicant with a prospect of upgrading to more favorable mortgage pricing and the timely detailing of requirements of the upgrade, may further encourage the applicant to follow through with the entity application process. Such encouragement may lead to the applicant transferring the applicant's business checking to an entity account and may lead to the applicant securing the mortgage with the entity. (It may be noted that the exemplary details of this and other examples herein are presented by way of illustration and not limitation.)

Illustrative embodiments of apparatus and methods in accordance with the principles of the invention may be described with reference to the accompanying drawings, which form a part hereof. It is to be understood that other embodiments may be utilized and that structural, functional and procedural modifications may be made without departing from the scope and spirit of the present invention.

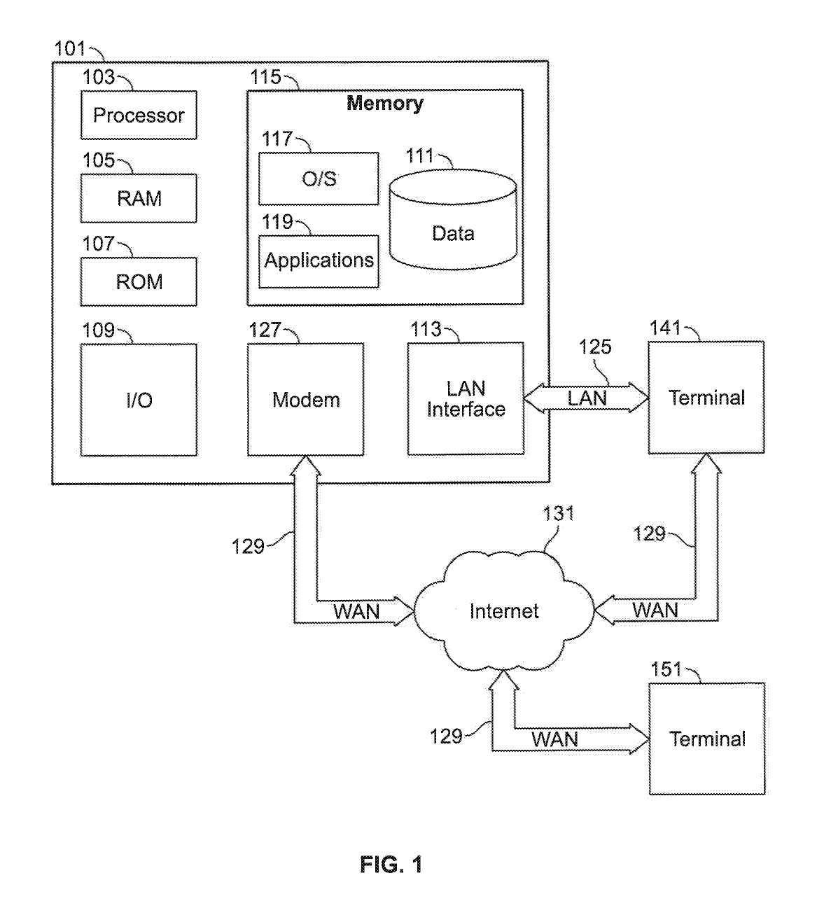

FIG. 1 is a block diagram that illustrates an exemplary computing device 101 (hereinafter, in the alternative, “server”) that may be used according to an illustrative embodiment of the invention. The computer server 101 may have a processor 103 for controlling overall operation of the server and its associated components, including RAM 105, ROM 107, input/output (“I/O”) module 109, and memory 115.

I/O module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 111. Alternatively, some or all of server 101 computer executable instructions may be embodied in hardware or firmware (not shown).

Application programs 119 used by server 101 may contain, according to an illustrative embodiment of the invention, computer executable instructions for implementing mortgage relationship-based pricing. Additionally, application program 119 used by server 101, according to an illustrative embodiment of the invention, may include computer executable instructions for invoking user functionality related to communication, such as email, short message service (SMS), and voice input and speech recognition applications.

Database 111 used by server 101 may provide, according to an illustrative embodiment of the invention, centralized storage of the information comprising entity customer accounts/instruments databases, reference profiles databases and/or databases of entity-set governing rubrics and rules, allowing interoperability of mortgage relationship-based pricing between different elements of the entity residing at different physical locations. Alternatively and/or additionally database 111 may be distributed over different elements of the entity.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 may be connected to LAN 125 through a network interface or adapter 113. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system may be operated in a client-server configuration to permit a user to retrieve web pages from a web-based server. Any of various conventional web browsers can be used to display and manipulate data on web pages.

Server 101, according to an illustrative embodiment of the invention, may implement mortgage relationship-based pricing as a process or set of process within server 101 and/or distributed over one or more remote network-linked computers, such as terminals 141 and 151.

Computing device 101 and/or terminals 141 or 151 may also be mobile terminals including various other components, such as a battery, speaker, and antennas (not shown).

Computing device 101 and/or terminals 141 or 151 may represent computers of diverse divisions, departments, branches, affiliates and/or other elements of the entity. Data to be received, retrieved, aggregated and/or processed in implementing mortgage relationship-based pricing may be resident at such divisions, departments, branches, affiliates and/or other elements of the entity.

Computing device 101 and/or terminals 141 or 151 may be used by the entity to solicit mortgage applications. Such solicitation may take the form of advertisement. Such advertisement may take the form of a screen-saver on a screen of terminal 141, which may, for example, represent a customer-accessible computer in a brick-and-mortar branch of the entity. Such advertisement may take the form of an entity-sent message attached to an online banking transaction transacted on terminal 151, which may, for example, represent a home-computer of an entity-customer. Terminals 141 and/or 151 may be used by mortgage applicants to initiate and/or pursue a mortgage application process.

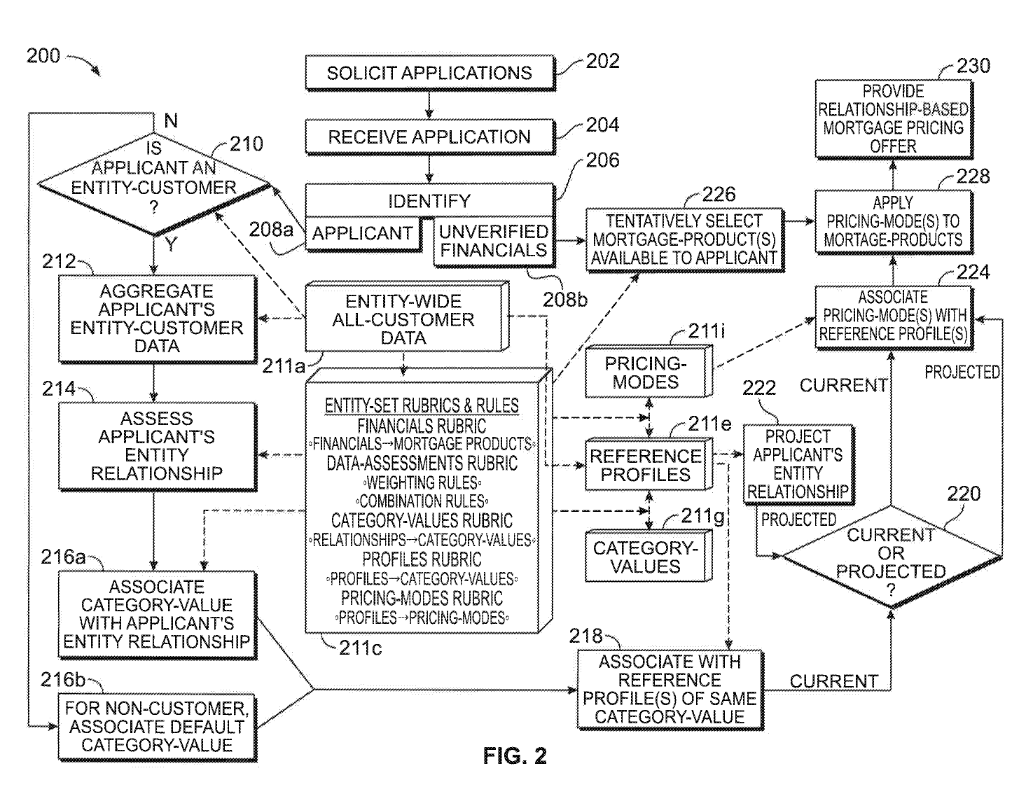

FIG. 2 shows illustrative process 200 for providing mortgage relationship-based pricing in accordance with the principles of the invention. Processes in accordance with the principles of the invention may include one or more features of the processes illustrated in FIG. 2. For the sake of illustration, steps of the illustrated processes will be described as being performed by a “system.” Such system may include one or more of the features of the apparatus shown in FIG. 1 and/or of any other suitable device or approach. The system may be provided by the entity implementing mortgage relationship-based pricing functions of the invention or by any other suitable individual, organization or modality.

In FIG. 2, illustrative process-flow is represented by solid arrows. Process-flow may include information-flow of data from process-step to process-step. Illustrative information-flow of data that one or more steps may make use of, be dependent upon, produce and/or be related to—but which may not, itself, be part of the process-flow—is represented by dashed arrows. The order of performance and/or description of steps of the processes in FIG. 2 is illustrative only. Each of the described steps need not be completed in the illustrated order or at all.

At step 202, the system may solicit applications for entity mortgage products. A solicitation may include advertisement. The solicitation may present information regarding entity mortgage products. The solicitation may present information regarding mortgage relationship-based pricing.

Step 202 solicitation may be directed to a wide audience. The solicitation may be directed to a specific audience. The specific audience may be entity-customers. Entity-customers to which the solicitation may be directed may include an entity-customer that may have been transacting an entity financial transaction that may require a means of secure, verifiable customer-identification. Such means of secure, verifiable customer-identification may include a form of photograph-bearing identification (such as a driver's license), a Personal Identification Number (“PIN”) and/or any other acceptable, secure means of identifying the customer. Such other acceptable, secure means of identifying the customer may include use of biometrics. The solicitation may be an entity-sent message attached to the transaction.

At step 204, the system may receive an application from an applicant for a first mortgage. Such receiving may include the applicant inquiring about entity mortgage products. The receiving may include receiving from the applicant identifying information about the applicant and about the mortgage for which the applicant may be applying. The receiving may include an entity loan officer receiving, and/or being informed of, application information. (The loan officer, other loan officer(s), and/or other entity agent(s) may contribute to system processing of the application information.) The information may include financial information regarding the applicant's finances and financial information regarding the property for which the applicant may seek the mortgage

The information received at step 204 may be received in response to step 202 solicitation. The application received at step 204 may be characterized through step 202 solicitation as an application of a verified entity-customer. The application received at step 204 may not be characterized through step 202 solicitation as an application of a verified entity-customer. The information received at step 204 may not be received in response to step 202 solicitation.

The information received at step 204 may not include information directly identifying the applicant as an entity-customer. The information received at step 204 may include information directly identifying the applicant as an entity-customer. The application received at step 204 may include one or more information-inputs by which the applicant may self-identify as an entity-customer. The information-input(s) by which the applicant may self-identify as an entity-customer may not include elements of verification at step 204. The information-input(s) by which the applicant may self-identify as an entity-customer may include one or more elements of verification at step 204. The element(s) of verification of such information-input(s) may involve use of means of securely identifying the customer. Securely identifying the customer may be achieved through customer-input and system-verification of the means of securely identifying the customer.

At step 206, the received information may be processed by the system for applicant-identifying information and for other information-content it may contain. The system may identify data of different types of received information. The system may separately process different types of information. Applicant-identifying information may be processed separately from financial information. Applicant-identifying information is shown at step 208a pending further processing. Financial information, typically unverified early in processing of a mortgage application, is shown at step 208b pending further processing.

At step 210, the system may run a test on the applicant-identifying information. The step 210 test may check and/or verify the received applicant-identifying information relative to the entity-customer status of the applicant. The received applicant-identifying information may include verified customer-identifying information and/or unverified customer-identifying information. The received applicant-identifying information may not include customer-identifying information. The step 210 test may check and/or verify the received applicant-identifying information relative to the entity-customer status of the applicant by comparing the received applicant-identifying information with entity-customer information that may be resident in a database. At step 210, the system may access such a database for customer-identifying information to check against and/or verify the applicant-identifying information of step 208a.

Step 211a depicts a database of entity-customer information. Database 211a may include information regarding all entity-customers. Database 211a may include information regarding a subset of all entity-customers. Database 211a may include current and/or historical information regarding entity-customers. The system may access database 211a and may retrieve entity-customer information from database 211a as a component-process of the step 210 test.

The step 210 test may not require confirmation of verified entity-customer identification information that may be contained in step 208a applicant-identifying information. The step 210 test may require confirmation of verified entity-customer identification information that may be contained in step 208a applicant-identifying information. The step 210 test may make use, for such confirmation, of entity-customer identification information that may be contained in step 208a applicant-identifying information. The step 210 test may make use of entity-customer database 211a information to confirm verified entity-customer identification information that may be contained in step 208a applicant-identifying information.

The step 210 test may make use of entity-customer database 211a information to verify unverified entity-customer identification information that may be contained in step 208a applicant-identifying information. The step 210 test may make use of entity-customer database 211a information to determine the entity-status of an applicant with no customer-identifying information contained in step 208a applicant-identifying information.

At step 210, step 208a applicant-identifying information may be accepted, confirmed, verified and/or determined as identifying the applicant as an entity-customer, i.e., as an applicant/customer. If the applicant's step 208a applicant-identifying information is not accepted, confirmed, verified or determined as identifying the applicant as an entity-customer, the system may proceed to step 216b. If the applicant's step 208a applicant-identifying information is accepted, confirmed, verified and/or determined as identifying the applicant as an applicant/customer, the system may proceed to step 212.

At step 212, the system may aggregate data relating to the current entity-status and/or to the entity-history of the applicant/customer. Such data may include information regarding accounts, financial instruments, loan products, mortgages and/or other entity products held by the applicant/customer at the entity and/or maintained for the applicant/customer by the entity. Such current status information and/or historical information regarding the applicant/customer's entity holdings and/or the entity's maintenance thereof, may be resident in database 211a. As a component-process of the step 212 aggregation of applicant/customer data, the system may access database 211a and may retrieve from database 211a current entity-status information and/or entity-history information that may pertain to the applicant/customer.

At step 214, the system may analyze the step 212 aggregated applicant/customer data. Such analysis may provide assessment of the applicant/customer's entity relationship(s). Assessment of the applicant/customer's entity relationship(s) may consider any factors that the entity may deem worthy of consideration in assessing the applicant/customer's entity relationship(s) in implementing mortgage relationship-based pricing.

Factors the entity may deem worthy of such consideration may include the number of the applicant/customer's entity holdings. Factors the entity may deem worthy of such consideration may include any current and/or historical adverse dealings between the applicant/customer and the entity (e.g., foreclosures, delinquencies, disagreements) pertaining to any of the applicant/customer's entity holdings.

Factors the entity may deem worthy of such consideration may include the nature of the applicant/customer's entity holdings. Consideration of the nature of the applicant/customer's entity holdings may include consideration of type(s) and/or diversity of the applicant/customer's entity accounts, financial instruments, loan products, mortgages and/or other entity products. Consideration of the nature of the applicant/customer's entity holdings may include consideration of monetary valuations (e.g., current, historical and/or projected balances) of the applicant/customer's entity holdings. Consideration of the nature of the applicant/customer's entity holdings may include consideration of longevity of the applicant/customer's entity holdings.

Which specific factors the entity may deem worthy of consideration in assessing the applicant/customer's entity relationship(s) in implementing mortgage relationship-based pricing, may be entity-set, entity-adjusted and/or entity-stored as a data-assessments rubric. The data-assessments rubric may also specify how to weight and/or combine the (weighted) factors deemed worthy of consideration in arriving at assessments of the applicant/customer's entity relationship(s). The rubric's rules for weighting and/or combining the (weighted) factors, and for any other processing of the factors deemed worthy by the entity, may be settable, adjustable and/or storable by the entity. The data-assessments rubric and its attendant rules may be a subset of a collection of entity-set, entity-adjustable and entity-stored rubrics and rules. The collection of entity-set, entity-adjustable and/or entity-stored rubrics and rules may be resident in a database. At step 214, the system may access such a database for the data-assessments rubric and rules to apply to and analyze the aggregated applicant/customer entity data in the assessment of the applicant/customer's entity relationship(s).

Step 211c depicts a database that may include a collection of entity-set, entity-adjustable and/or entity-stored rubrics and rules. The rubrics and rules may be based at least in part on legal, practical and other considerations by which the entity is regulated. The rubrics and rules may be based at least in part on entity-experience. The entity-experience upon which the rubrics and rules may be based at least in part may include information contained in entity-customer database 211a. (Database 211c may include also time-stamped archives of versions of the collection of rubrics and rules superseded by successive versions produced by entity-adjustments of rubrics and/or rules. For a given run of process 200, a collection of rubrics and rules in force at the time of execution of step 210 may be used, or may be retained and/or retrieved from archive for use, throughout the remaining steps of process 200.)

The collection of entity-set rubrics and rules of database 211c may include a Financials rubric and rules for treating financial information, such as the unverified financials of step 208b. The collection of entity-set rubrics and rules of database 211c may include a Category-Values rubric and rules for relating category-values to applicant/customer's entity relationships assessments. The collection of entity-set rubrics and rules of database 211c may include a Profiles rubric and rules for relating category-values to reference profiles. The collection of entity-set rubrics and rules of database 211c may include a Pricing Modes rubric and rules for relating pricing modes to reference profiles.

The collection of entity-set rubrics and rules of database 211c may include a Data-Assessments rubric and rules. The Data-Assessments rubric may specify the factors the entity may deem worthy of consideration in assessing the applicant/customer's entity relationship(s). The Data-Assessments rules may include rules for weighting and/or combining the (weighted) factors deemed worthy of consideration in arriving at assessments of the applicant/customer's entity relationship(s). As a component-process of step 214, the system may access database 211c for the Data-Assessments rubric and rules to apply to and analyze step 212 aggregated applicant/customer entity data in the assessment of the applicant/customer's entity relationship(s).

At steps 216a and 216b, the system may associate with the assessed applicant/customer entity relationship(s) one or more category-values. As a component-process of step 216, the system may access database 211c for the Category-Values rubric and rules for relating category-values to applicant/customer's entity relationships assessments.

At step 216a, the system may associate one or more category-values with assessments of applicant/customer entity relationship(s) the system may have made in step 214. At step 216b, the system may associate default category-value(s) with the non-customer entity relationship assessment the system may have made in step 210 for an applicant with step 208a applicant-identifying information that may not have been accepted, confirmed, verified or determined as identifying the applicant as an entity-customer. The default category-values may be linked to pricing modes that specify no special mortgage pricing for the applicant that is not an entity-customer.

The system may proceed to step 218 to further process the category-value(s) associated in step 216a or in step 216b with the applicant's assessed entity-relationship(s). At step 218, the system may associate the step 216a-associated or step 216b-associated category-value(s) with reference profile(s) of the same category-value(s). The reference profile(s) may be resident in reference profiles database 211e.

Reference profiles database 211e may include information on entity holdings of anticipated/prospective, actual or theoretical entity-customers. The reference profiles database 211e information may be based upon entity-experience. The entity-experience upon which the reference profiles database 211e information may be based, may include the entity-customer database 211a information. The reference profiles database 211e information may be set by rubrics and rules of database 211c. The reference profiles database 211e information may span the set of all known and/or anticipated configurations of entity-customer entity holdings, or subsets thereof. Configurations of entity-customer entity holdings may differ as to breadth and depth of entity-relationship(s) reflected in the range of types, valuations, longevities and/or other features of the configurations' entity holdings.

The reference profiles database 211e information may include subsets of known and/or anticipated configurations of entity-customer entity holdings. A reference profile may include a particular known and/or anticipated configuration of entity-customer entity holdings. At least one such configuration may represent a non-entity-customer with no entity holdings.

A reference profile may be linked to a pricing mode. The linkage of a reference profile to a pricing mode may be set by the database 211c Pricing Modes rubric and rules for relating pricing modes to reference profiles. The pricing modes linked to reference profiles database 211e may be resident in database 211i.

A reference profile may be linked to a category-value. The linkage of a reference profile to a category-value may be set by the database 211c Profiles rubric and rules for relating category-values to reference profiles. The category-values linked to reference profiles database 211e may be resident in database 211g.

At step 218, the system may access the reference profiles database 211e to associate the step 216a-associated or step 216b-associated category-value(s) with reference profile(s) of the same category-value(s). Reference profiles associated in step 218 with the category-value(s) of the applicant's assessed entity-relationship may represent current reference profiles.

The system may pass the current reference profile(s) to step 220. Step 220 represents a switch through which may pass either current reference profiles or projected reference profiles, depending on the setting of switch 220.

The system and/or the entity loan officer handling the application of the applicant may set the setting of switch 220 to pass projected reference profiles. At step 222, the system and/or the entity loan officer may access database 211e to retrieve projected reference profiles, and may pass the projected reference profiles through switch 220 to step 224. This aspect of process 200 is followed in more detail below with regard to providing upgrades over current applicant/customer-favorable mortgage pricing offers.

Toward providing the current applicant/customer-favorable mortgage pricing offer(s), the system and/or the entity loan officer may set the setting of switch 220 to pass the current reference profile(s) from step 218 through switch 220 to step 224. At step 224, the system may associate one or more pricing-modes with the current reference profile(s) passed through switch 220. The system may access database 211i to retrieve the pricing mode(s) linked to the reference profile(s) passed through switch 220 and to associate the linked pricing mode(s) to the current reference profile(s). The system may pass the profile-associated pricing mode(s) to step 228.

At step 226, the system may tentatively select entity mortgage products available to the applicant applying for a mortgage for the property. The selection at step 226 of entity mortgage products available to the applicant for the property may be based upon the step 208b unverified financials. At step 226, the system may access database 211c for the Financials rubric and rules to apply to the step 208b unverified financials information to tentatively select the entity mortgage products available to the applicant for the property. Selected, also, may be settings of various parameters associated with the mortgage products. Such parameters may include the conventional pricings and terms of the mortgage products. The system may pass information related to the entity mortgage products available to the applicant for the property to step 228.

At step 228, the system may apply the profile-associated pricing mode(s) to the pricing of the mortgage-product(s) that the entity may make available to the applicant for the property. In applying the pricing mode(s) to the pricing of the mortgage-product(s) that the entity may make available to the applicant, the system may calculate mortgage pricing(s) to be offered the applicant. The pricing(s) to be offered the applicant may represent relationship-based pricing for the mortgage-product(s). Information pertaining to the relationship-based mortgage pricing(s) may be passed to step 230, at which step the relationship-base mortgage pricing(s) offer may be provided to the applicant.

Alternatively and/or additionally, the loan officer (and/or system) may explore upgraded category-values that may be attainable by the applicant and that may lead to upgraded, more favorable mortgage pricing offers than provided at step 230 by passing current reference profile(s) through switch 220. For example, by the system passing a non-entity-customer applicant's current reference profile through switch 220, the non-entity-customer applicant may be offered conventional, non-special mortgage pricing at step 230. As another example, by the system passing an entity-customer applicant's current low-category-value-associated reference profile through switch 220, the applicant/customer may be offered a modest relationship-based discounting of mortgage pricing at step 230. Process 200 accommodates exploring upgrading such exemplary pricing to more applicant-favorable pricing.

In exploring upgrades, the loan officer (and/or system) may set the setting of switch 220 to pass projected applicant/customer relationship profiles. At step 222, the loan officer (and/or system) may access reference profiles database 211e and retrieve from database 211e projected reference profiles linked, through broader and/or deeper customer entity relationships than currently enjoyed by the applicant, to enhanced category-values. The projected reference profiles may be passed through switch 220 to step 224 for association with pricing-mode(s) and the associated pricing mode(s) may be applied at step 228 to the available mortgage products. As a result, mortgage pricing more favorable to the applicant than that which may have resulted from processing the applicant's current reference profile(s), may be offered the applicant at step 230.

As will be appreciated by one of skill in the art, the invention described in the aforementioned steps and parts of the figures and in the specification herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

Thus, apparatus, methods and media for providing mortgage relationship-based pricing according to the invention have been provided. Persons skilled in the art will appreciate that the present invention can be practiced in embodiments other than the described embodiments, which are presented for purposes of illustration rather than of limitation, and that the present invention is limited only by the claims that follow.

1-7. (canceled)

8. An apparatus for providing relationship-based loan product pricing to a customer of an entity offering financial products, the customer applying for an entity loan product, the apparatus comprising:
a receiving device configured to receive information from the entity customer; and
a digital logical processing device configured to:
assess an entity relationship profile of the customer, the profile based at least in part on a status of an entity product held by the customer;
determine which of a plurality of reference entity relationship profiles corresponds to the customer's entity relationship profile, the plurality of reference entity relationship profiles being linked to a set of relationship-based loan product pricing rules;
based on the reference entity relationship profile determined to correspond to the customer's entity relationship profile, select a relationship-based loan product pricing rule from the set of relationship-based loan product pricing rules; and
calculate a pricing of the entity loan product, the pricing calculated at least in part based on the received information and according to the selected relationship-based loan product pricing rule.

9. The apparatus of claim 8, wherein the set of relationship-based loan product pricing rules comprises a rule of conveying an award of monetary value to the customer.

10. The apparatus of claim 8, wherein the loan product is a mortgage product.

11. The apparatus of claim 10, wherein the set of relationship-based loan product pricing rules comprises a rule of adjustment of a cost associated with the mortgage product.

12. The apparatus of claim 10, wherein the set of relationship-based loan product pricing rules comprises a rule of adjustment of an interest rate associated with the mortgage product.

13. The apparatus of claim 8, wherein the status of the entity product held by the customer corresponds to a monetary valuation of the entity product held by the customer.

14. The apparatus of claim 8, wherein the status of the entity product held by the customer corresponds to a transaction history of the entity product held by the customer.

15. The apparatus of claim 8, wherein at least one of the plurality of reference entity relationship profiles comprises a monetary valuation of a customer-held entity financial product.

16. The apparatus of claim 8, wherein at least one of the plurality of reference entity relationship profiles comprises a transaction history of a customer-held entity financial product.

17. The apparatus of claim 8 further comprising, if the customer does not hold an entity product, the logical processing device being configured to:
assess an entity relationship profile of the customer based on absence of a customer-held entity product;
determine a reference entity relationship profile corresponding to the customer's entity relationship profile being based on absence of a customer-held entity product;
based on the reference entity relationship profile determined to correspond to the customer's entity relationship profile being based on absence of a customer-held entity product, select a relationship-based loan product pricing rule of no adjustment of a cost of the loan product from the set of relationship-based loan product pricing rules; and
calculate a pricing of the entity loan, product, the pricing calculated at least in part based on the received information and according to the selected rule of no adjustment.

18. The apparatus of claim 8, wherein the logical processing device is configured to determine, proximal to the customer applying for the entity loan product, which of the plurality of reference entity relationship profiles corresponds to the customer's entity relationship profile.

19. The apparatus of claim 18,
wherein:
the entity relationship profile of the customer is a first customer profile;
the reference entity relationship profile corresponding to the first customer profile is a first reference profile;
the relationship-based loan product pricing rule selected based on the first reference profile is a first relationship-based loan product pricing rule; and
the pricing calculated at least in part based on the received information and according to the first relationship-based loan product pricing rule is a first pricing; and
further comprising, the logical processing device being configured to:
assess a second customer profile, the second customer profile based at least in part on a status, after the first pricing, of an entity product held by the customer;
determine which of the plurality of reference entity relationship profiles corresponds to the second customer profile;
based on the reference entity relationship profile determined to correspond to the second customer profile, select a second relationship-based loan product pricing rule from the set of relationship-based loan product pricing rules; and
calculate a second pricing of the entity loan product, the pricing calculated at least in part based on the received information and according to the second relationship-based loan product pricing rule.

20. The apparatus of claim 19, further comprising a communication device configured to communicate, proximal to the customer applying for the loan product, the first pricing and the second pricing.
